(19) United States
(12) Patent Application Publication
(10) Pub. No.: US 2024/0237660 A1
(43) Pub. Date: Jul. 18, 2024

(54) COOKING EQUIPMENT HAVING SMOKING FUNCTION

(71) Applicant: Samsung Electronics Co., Ltd., Suwon-si (KR)

(72) Inventors: Sungkoo CHO, Suwon-si (KR); Yunwon MOON, Suwon-si (KR); Mukyong KIM, Suwon-si (KR); Hyosuk KIM, Suwon-si (KR); Hohyun RYU, Suwon-si (KR); Sangjin JEONG, Suwon-si (KR); Kyungah CHANG, Suwon-si (KR)

(73) Assignee: Samsung Electronics Co., Ltd., Suwon-si (KR)

(21) Appl. No.: 18/623,736

(22) Filed: Apr. 1, 2024

Related U.S. Application Data
(63) Continuation of application No. PCT/KR2022/012970, filed on Aug. 30, 2022.

(30) Foreign Application Priority Data
Oct. 1, 2021 (KR) 10-2021-0131136

(51) Int. Cl. A23B 4/056; A23B 4/052; F24C 7/02

(52) U.S. Cl. CPC A23B 4/056; A23B 4/0523; F24C 7/02

(57) ABSTRACT

A cooking appliance includes a cooking chamber having a cooking space in which an object to be cooked is placeable, a heating member configured to heat the object based on the object being placed in the cooking chamber, and a smoking module configured to smoke the object placed in the cooking chamber, wherein the smoking module includes: a capsule placement unit in which a capsule containing smoking chips is insertable and placeable therein; a smoke generation unit configured to penetrate one end of the capsule based on the capsule being paced in the capsule placement unit and heat the smoking chips inside the capsule such that smoke is generated from the smoking chips; and a smoke transfer unit configured to transfer the smoke generated from the smoking chips to the cooking chamber.

### CROSS-REFERENCE TO RELATED APPLICATIONS

This application is a continuation application, under 35 U.S.C. § 111(a), of International Patent Application No. PCT/KR2022/012970, filed on Aug. 30, 2022, which claims the priority benefit of Korean Patent Application No. 10-2021-0131136, filed on Oct. 1, 2021 in the Korean Patent and Trademark Office, the disclosures of which are hereby incorporated by reference in their entirety.

### TECHNICAL FIELD

Embodiments provide a cooking appliance having a smoking function.

### BACKGROUND ART

For cooking an object to be cooked, for example, food, a cooking appliance that is operated by an external power source may be used. Examples of such cooking appliances include electric ovens, microwave ovens, and electric heat blowers (e.g., air fryers). Such cooking appliances cook the object to be cooked by applying hot air or emitting microwaves to the object to be cooked.

In addition, various demands for food are emerging due to dieting, camping, etc., and one of them is the demand for smoked food prepared by smoking the object to be cooked. In order for an electronic cooking appliance to satisfy such demands, a method of allowing a user to put smoking chips in the electronic cooking appliance and combust the smoking chips may be considered. However, in such a method, a process of preparing the smoking chips and removing the smoking chips after cooking may be quite cumbersome for the user, and the flavor of food varies depending on the amount of smoking chips, and thus may be inconsistent.

### DISCLOSURE

### Technical Solution

According to an embodiment, a cooking appliance having a smoking function includes a cooking chamber having a cooking space in which an object to be cooked is placeable, a heating member configured to heat the object based on the object being placed in the cooking chamber, and a smoking module configured to smoke the object placed in the cooking chamber, wherein the smoking module may include: a capsule placement unit in which a capsule containing smoking chips is insertable and placeable therein; a smoke generation unit configured to generate smoke by heating the smoking chips inside the capsule based on the capsule being placed in the capsule placement unit; and a smoke transfer unit configured to transfer the smoke generated from the smoking chips to the cooking chamber.

The capsule placement unit may include a seating groove in which the capsule to be seated, the seating groove corresponding to an outer shape of the capsule, and the smoking module may further include a capsule door to open or close the capsule placement unit.

The smoke generation unit may include a combustion heater that is movable between a protrusion position in which the combustion heater protrudes toward the seating groove to penetrate an end of the capsule placed in the capsule placement unit, and a retraction position in which the combustion heater is retracted to enable a placement of the capsule in the capsule placement unit.

The combustion heater does not protrude toward the seating groove to enable insertion of the capsule into the seating groove.

Based on the capsule door being closed, the combustion heater may move from the retraction position to the protrusion position.

The combustion heater may heat the smoking chips at a temperature of 480° C. or lower.

An end of the combustion heater may have a sharp shape to penetrate one end of the capsule based on the combustion heater being moved to the protrusion position.

The smoke transfer unit may include a smoke passage formed therein to connect the capsule placement unit with the cooking chamber so that the smoke moves therethrough, and a blower arranged in the smoke passage to control a movement direction of the smoke.

The cooking appliance may further include a smoke detection unit configured to detect the smoke moving through the smoke passage.

The smoke detection unit may include a light-emitting unit configured to emit light, and a light receiving unit configured to receive the emitted light.

The smoke detector may be arranged upstream of the blower.

The smoke passage may be configured to allow the smoke to circulate therein, and the smoking module may further include a filter arranged in the smoke passage to remove the smoke by using a liquid.

The filter may include a liquid cartridge that is detachable from a main body and stores the liquid.

The filter may further include a purification filter to purify air.

The heating member may be further configured to heat an inside of the cooking chamber or apply microwaves to the object to be cooked.

The smoking module further comprises the capsule having a smoking function, and the capsule may include: a basket accommodating the smoking chips; and a smoke discharge unit arranged at one end of the basket and configured to pass the smoke generated from the smoking chips.

The capsule may further include a capsule lid that blocks the smoke discharge unit and is removable from the basket.

The smoke discharge unit may formed as a mesh shape including mesh holes, and configured to block leakage of the smoking chips and pass the smoke generated from the smoking chips through the mesh holes.

The sizes of the mesh holes of the smoke discharge unit may be less than the sizes of the smoking chips.

The sizes of the smoking chips may be 5 mm or less to enable combustion by the combustion heater.

The basket may comprise a through hole formed at an other end of the basket, and into which the combustion heater may be inserted, and a cover member provided at the other end of the basket, and covers the through hole.

The combustion heater may not protrude toward the seating groove to enable insertion of the capsule into the seating groove.

### DESCRIPTION OF DRAWINGS

FIG. 1 is a perspective view illustrating an example of an electronic cooking appliance according to an embodiment.

FIG. 2 is a block diagram conceptually illustrating an electronic cooking appliance according to an embodiment.

FIG. 3 is a block diagram conceptually illustrating a smoking module of an electronic cooking appliance according to an embodiment.

FIG. 4 is a perspective view illustrating an example of a smoking module according to the embodiment.

FIG. 5 is a cross-sectional view of the smoking module of FIG. 4 taken along a line parallel to the side surface thereof.

FIGS. 6A and 6B are diagrams illustrating movements of a combustion heater according to opening and closing of a capsule door.

FIG. 7 is a diagram for describing a structure of a capsule according to an embodiment.

FIG. 8 is a diagram for describing use of the capsule of FIG. 7.

FIG. 9 is a diagram for describing a smoke transfer unit of a smoking module according to an embodiment.

FIG. 10 is a diagram for describing a smoke detection unit according to an embodiment.

FIG. 11 is a diagram for describing a filter according to an embodiment.

### MODE FOR INVENTION

Hereinafter, example embodiments of the present disclosure will be described in detail with reference to the accompanying drawings. Like reference numerals in the drawings indicate parts or components that perform substantially the same functions.

Terms such as “first” or “second” may be used to describe various elements, but the elements are not limited by the terms. These terms are only used to distinguish one element from another element. For example, a first element may be referred to as a second element, and a second element may be referred to as a first element in a similar manner, without departing from the scope of the present disclosure. The term “and/or” includes any and all combinations of one or more of the associated listed items.

Terms used herein are for describing embodiments and are not intended to limit the scope of the present disclosure. Singular forms are intended to include plural forms as well, unless the context clearly indicates otherwise. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Like reference numerals in the drawings indicate members that perform substantially the same functions.

Embodiments provide a cooking appliance for easily performing smoking when cooking food.

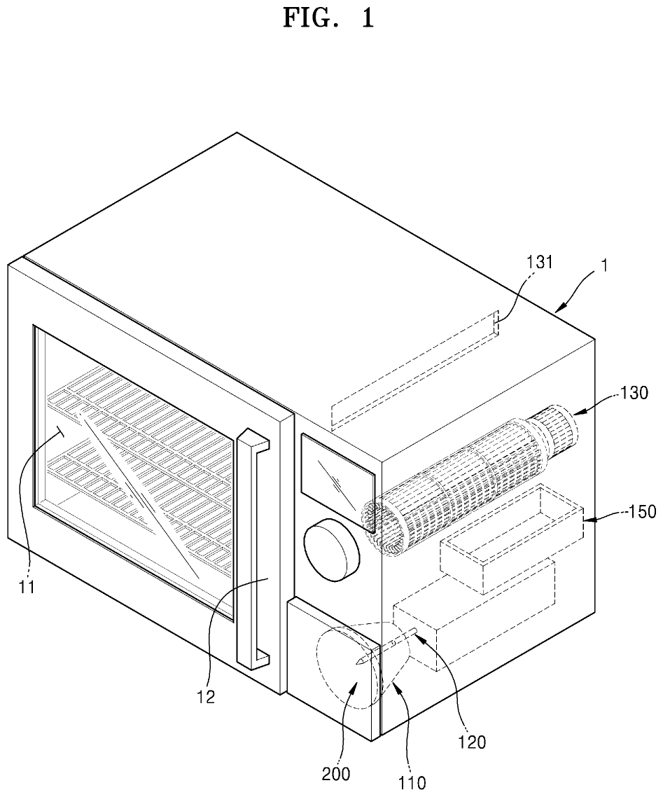

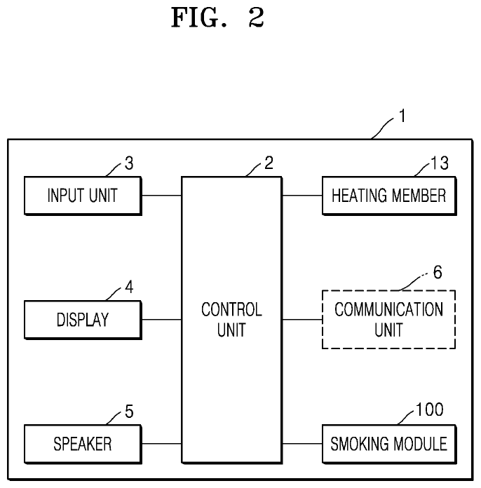

FIG. 1 is a perspective view illustrating an example of an electronic cooking appliance 1 according to an embodiment, and FIG. 2 is a block diagram conceptually illustrating the electronic cooking appliance 1 according to an embodiment.

Referring to FIGS. 1 and 2, the electronic cooking appliance 1 includes a cooking chamber 11 that provides a cooking space in which an object to be cooked is placed, a heating member 13 configured to heat the object to be cooked, and a smoking module 100 configured to smoke the object to be cooked.

The electronic cooking appliance 1 may be an electric oven, an electronic oven, a microwave oven, or an electric heat blower. However, the type of the electronic cooking appliance 1 is not limited thereto, and the electronic cooking appliance 1 may be implemented in various forms. For example, the electronic cooking appliance 1 may have an electric oven function and a microwave oven function, or may have an electric oven function and an electric heat blower function. In addition, the electronic cooking appliance 1 may be implemented as any device that is operated by an external power source to perform cooking, and may be referred to as a cooking appliance.

The cooking space of the cooking chamber 11 may be implemented in the shape of a rectangular parallelepiped or a regular hexahedron. However, the shape of the cooking space is not limited thereto, and the cooking space may be implemented in various shapes. The cooking chamber 11 may be opened and closed by a chamber door 12.

The heating member 13 directly or indirectly heats the object to be cooked placed in the cooking chamber 11. The heating member 13 may heat the object to be cooked by using various heating methods. For example, the heating member 13 may heat air inside the cooking chamber 11 to heat the object to be cooked by using convection heat. For example, the heating member 13 may irradiate the inside of the cooking chamber 11 with microwaves to heat the object to be cooked through dielectric heating. The heating member 13 may perform various heating methods depending on the type of the electronic cooking appliance 1.

A control unit 2 may include a processor configured to control the operation of the heating member 13. The processor of the control unit 2 may be electrically connected to the heating member 13, an input unit 3, a display 4, a speaker 5, the smoking module 100, and a communication unit 6. The processor of the control unit 2 may control the heating member 13, the smoking module 100, the speaker 5, and the display 4 based on an user input obtained through the input unit 3. The communication unit 6 may be connected to a server or an external electronic device in a wired or wireless manner. However, the communication unit 6 is an optional component and may be omitted as needed.

A user may input a recipe, a cooking time, a cooking method, or the like for the object to be cooked, through the input unit 3. The control unit 2 controls the heating member 13 and the smoking module 100 based on a user input. In addition, the control unit 2 may visually and audibly provide information about a cooking state, a cooking time, a cooking method, or the like for the object to be cooked, through the display 4 and the speaker 5.

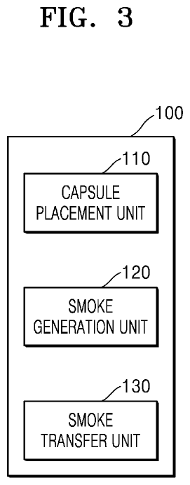

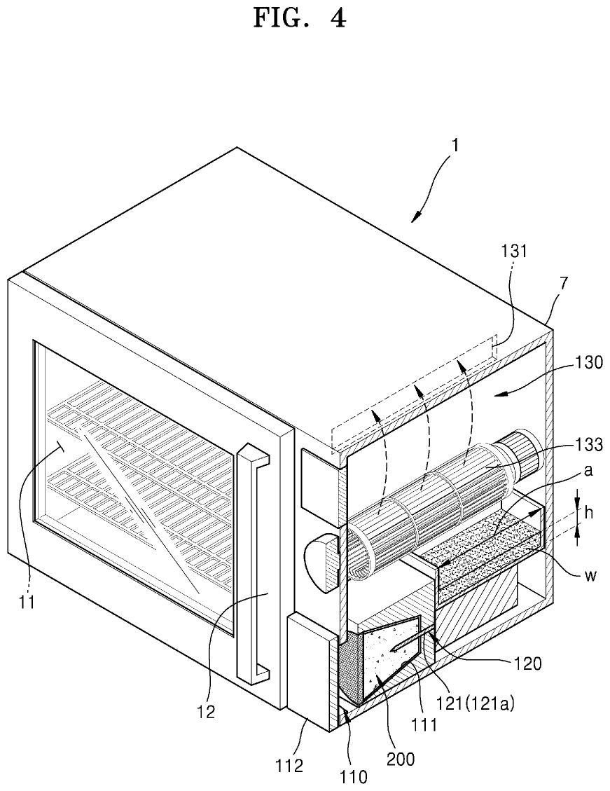

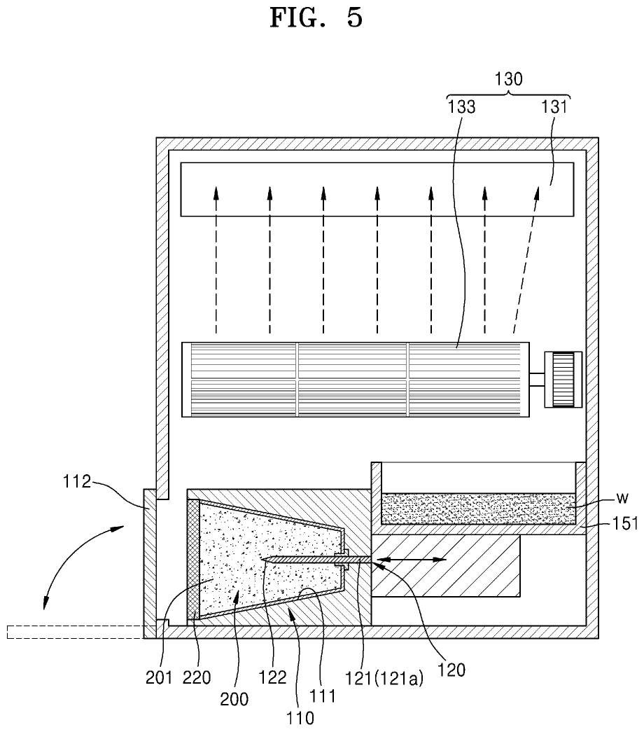

FIG. 3 is a block diagram conceptually illustrating the smoking module 100 of the electronic cooking appliance 1 according to an embodiment, and FIG. 4 is a perspective view illustrating an example of the smoking module 100 according to the embodiment. FIG. 5 is a cross-sectional view of the smoking module 100 of FIG. 4 taken along a line parallel to the side surface thereof.

Referring to FIGS. 3 to 5, the smoking module 100 includes a capsule placement unit 110, a smoke generation unit 120, and a smoke transfer unit 130.

A capsule 200 containing smoking chips 201 is inserted and placed in the capsule placement unit 110. The capsule placement unit 110 includes a seating groove 111 in which the capsule 200 is seated. The seating groove 111 has a shape corresponding to the outer shape of the capsule 200. The capsule 200 may be placed at a certain position in the capsule placement unit 110 through the seating groove 111. The capsule placement unit 110 may be opened and closed by a capsule door 112.

The smoke generation unit 120 heats the smoking chips 201 inside the capsule 200 such that smoke is generated from the smoking chips 201. The smoke generation unit 120 penetrates one side of the capsule 200 placed in the capsule placement unit 110 and heats the smoking chips 201. The smoke generation unit 120 includes a combustion heater 121 configured to heat the smoking chips 201. The operation of the combustion heater 121 may be controlled by the control unit 2.

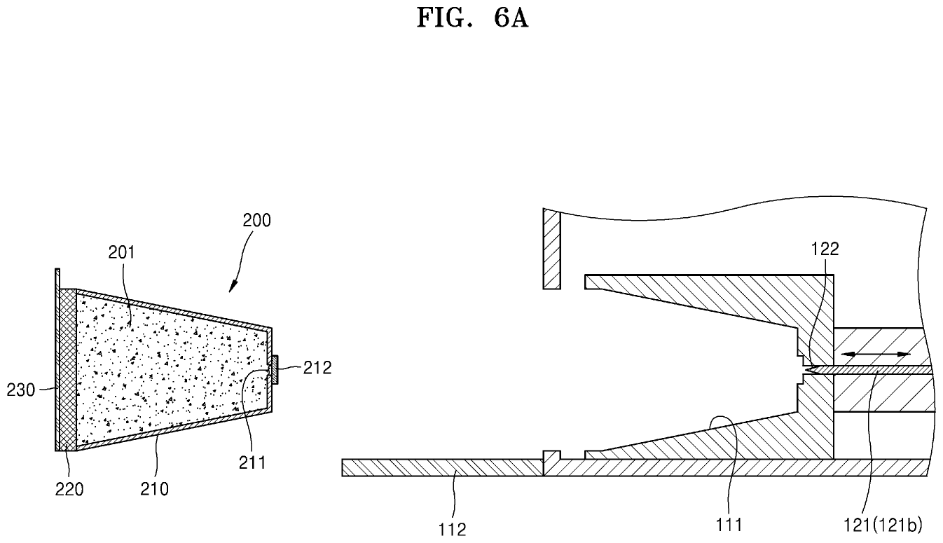

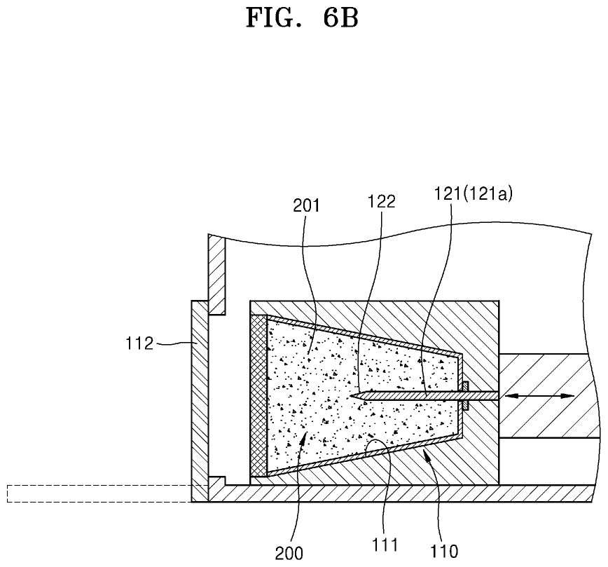

The combustion heater 121 is movable between a protrusion position 121a in which the combustion heater 121 protrudes toward the seating groove 111, and a retraction position 121b (see FIG. 6A) in which the combustion heater 121 does not protrude toward the seating groove 111. The combustion heater 121 penetrates an end of the capsule 200 when in the protrusion position 121a, and is not inserted into the capsule 200 when in the retraction position 121b. The combustion heater 121 may move in conjunction with the operation of the capsule door 112.

FIGS. 6A and 6B are diagrams illustrating movements of the combustion heater 121 according to opening and closing of the capsule door 112. Referring to FIG. 6A, when the capsule door 112 is opened, the combustion heater 121 is located at the retraction position 121b. Accordingly, in a process of inserting the capsule 200 into the seating groove 111 of the capsule placement unit 110, the combustion heater 121 is prevented from being in contact with the capsule 200.

Referring to FIG. 6B, when the capsule door 112 is closed after inserting and placing the capsule 200 in the seating groove 111 of the capsule placement unit 110, the combustion heater 121 moves from the retraction position 121b to the protrusion position 121a. In a process of moving the combustion heater 121 to the protrusion position 121a, the end 122 of the combustion heater 121 penetrates the end of the capsule 200 to be inserted into the capsule 200.

The combustion heater 121 inserted into the capsule 200 is in contact with the smoking chips 201 accommodated in the capsule 200. Thereafter, when the combustion heater 121 is operated by the control unit 2, the combustion heater 121 heats the smoking chips 201 to a certain temperature in order to combust the smoking chips 201. For example, the combustion heater 121 may heat the smoking chips 201 to a temperature of 480° C. or lower. Although not illustrated in the drawings, oxygen is supplied to the capsule placement unit 110 from the outside. Accordingly, the combustion heater 121 may cause incomplete combustion of the smoking chips 201 inside the capsule 200, and thus generate smoke. The heating temperature of the combustion heater 121 may be 150° C. or higher for combustion of the smoking chips 201.

The end 122 of the combustion heater 121 may have a sharp shape. For example, the combustion heater 121 may have a shape having a width that decreases toward the end 122. Accordingly, when the combustion heater 121 moves to the protrusion position 121a, the combustion heater 121 may easily penetrate one end of the capsule 200.

Smoke may be generated inside the capsule 200 by the smoke generation unit 120, and discharged through the other end of the capsule 200. The capsule 200 for use in the electronic cooking appliance 1 may have a structure that facilitates heating by the combustion heater 121 and smoke discharge, while preventing the smoking chips 201 from being discharged to the outside.

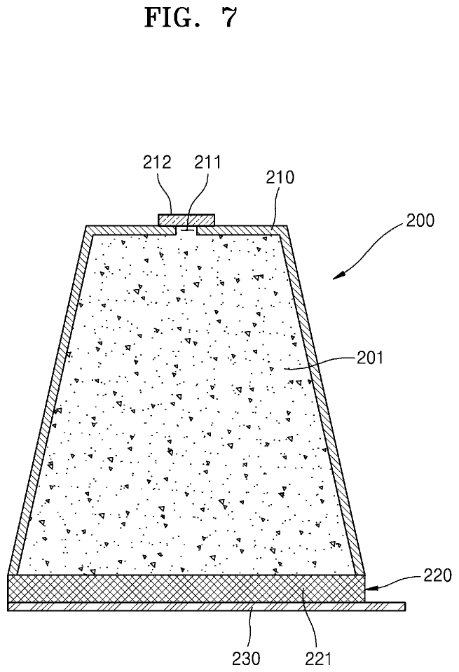

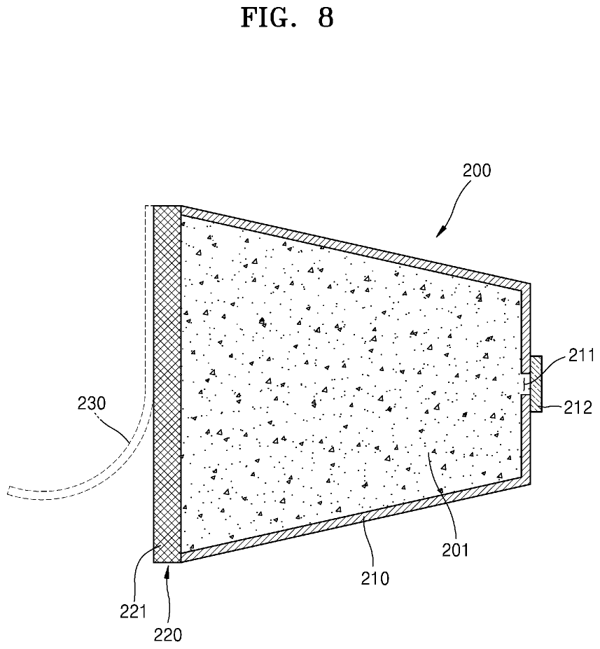

FIG. 7 is a diagram for describing a structure of the capsule 200 according to an embodiment. FIG. 8 is a diagram for describing use of the capsule 200 of FIG. 7.

Referring to FIG. 7, the capsule 200 includes the smoking chips 201, a basket 210 accommodating the smoking chips 201, and a smoke discharge unit 220 arranged at an end of the basket 210.

When the smoking chips 201 are heated to a certain temperature or higher, smoke is generated. The smoke may have a certain smoky flavor. The material of the smoking chips 201 may include at least one of apple tree, oak tree, grapevine, cherry tree, jujube tree, hickory, peach tree, and mesquite. The smoking chips 201 may be prepared by cutting or crushing at least one of apple tree, oak tree, grapevine, cherry tree, jujube tree, hickory, peach tree, and mesquite, or by processing the crushed pieces.

The smoking chips 201 may have a small size to enable combustion by the combustion heater 121. For example, the smoking chips 201 may have the form of sawdust. For example, the size of the smoking chip 201 may be 5 mm or less. When the size of the smoking chips 201 contained in the capsule 200 is not constant, the size of the smoking chip 201 may be an average size.

A through hole 211 into which the combustion heater 121 may be inserted, and a cover member 212 covering the through hole 211 are provided at one end of the basket 210. The cover member 212 may have a structure and a material to be easily penetrated by the combustion heater 121. For example, the cover member 212 may be in the form of an aluminum foil. However, the structure and material of the cover member 212 are not limited thereto and may be variously modified.

The smoke discharge unit 220 may be arranged at the other end of the basket 210. The smoke discharge unit 220 may have a mesh structure configured to block leakage of the smoking chips 201 and pass smoke generated from the smoking chips 201. As an example of the configuration, the size of a mesh hole 221 may be less than the size of the smoking chip 201. For example, the size of the mesh hole 221 may be less than the minimum size of the smoking chips 201. The size of the mesh hole 221 may be 1 mm or less.

A capsule lid 230 may be arranged on an outer portion of the smoke discharge unit 220. The capsule lid 230 blocks the smoke discharge unit 220 and is removable from the basket 210. The capsule lid 230 may have a flexible material and structure to be easily removed by the user. For example, the capsule lid 230 may be in the form of an aluminum foil. However, the structure and material of the capsule lid 230 are not limited thereto and may be variously modified.

Before using the capsule 200, the capsule lid 230 prevents the smoking chips 201 from leaking out through the smoke discharge unit 220, and prevents the flavor of the smoking chips 201 from spreading to the outside. When using the capsule 200, as illustrated in FIG. 8, the user separates the capsule lid 230 from the basket 210 and inserts and places the capsule 200 from which the capsule lid 230 is removed, in the capsule placement unit 110 of the electronic cooking appliance 1.

Referring back to FIGS. 4 and 5, the smoking chips 201 in the capsule 200 arranged in the capsule placement unit 110 are heated by the combustion heater 121 to generate smoke. The smoke generated from the capsule 200 is transferred to the cooking chamber 11 by the smoke transfer unit 130.

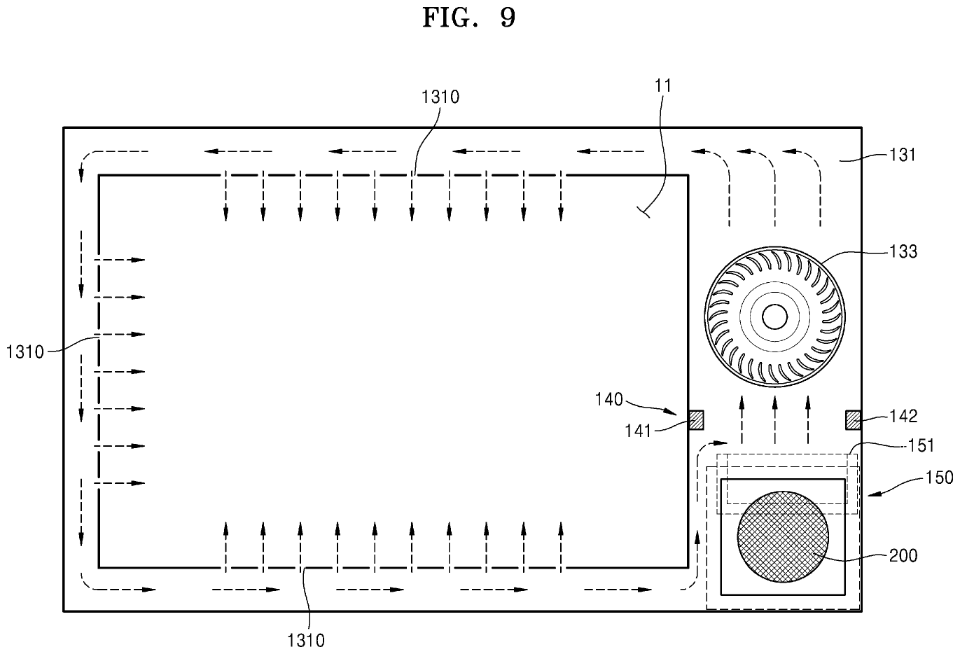

FIG. 9 is a diagram for describing the smoke transfer unit 130 of the smoking module 100 according to an embodiment, and is a cross-sectional view of the electronic cooking appliance 1 of FIG. 2 taken along a line parallel to the front surface thereof.

Referring to FIGS. 4 and 9, the smoke transfer unit 130 includes a smoke passage 131 that provides a passage through which smoke moves, and a blower 133 arranged in the smoke passage 131 to control the movement direction of the smoke. The operation of the blower 133 may be controlled by the control unit 2.

The smoke passage 131 is in communication with the capsule placement unit 110 and the cooking chamber 11. Accordingly, smoke generated in the capsule placement unit 110 may be transferred to the cooking chamber 11. Smoke holes 1310 connected to the cooking chamber 11 are provided in the smoke passage 131.

The blower 133 includes a blowing fan that moves the smoke in a certain direction. The blowing fan may move the smoke in a certain direction, for example, in a clockwise direction. Accordingly, the smoke discharged from the capsule placement unit 110 moves from the right side to the top of the cooking chamber 11 along the smoke passage 131. In this process, the smoke may be supplied into the cooking chamber 11 through the smoke holes 1310, and the object to be cooked inside the cooking chamber 11 may be smoked.

An example in which a single blower 133 is arranged on the right side is described in the embodiment, but the present disclosure is not limited thereto. For example, although not illustrated, a plurality of blowers 133 may be arranged at various positions.

The smoking module 100 further includes a smoke detection unit 140 arranged in the smoke passage 131 and configured to detect smoke moving through the smoke passage 131. The smoke detection unit 140 may detect generation of smoke or the concentration of smoke. The control unit 2 may control at least one of the blower 133 and the combustion heater 121 based on a result of detection by the smoke detection unit 140. For example, the control unit 2 may increase the temperature of the combustion heater 121 when the smoke detection unit 140 determines that smoke is not generated, or may adjust the rotational speed of the blower 133 according to the concentration of smoke.

The smoke detection unit 140 may be arranged upstream of the blower 133. Accordingly, it is possible to measure the state of smoke before it is distributed by the blower 133.

The smoke detection unit 140 is a sensor configured to detect smoke particles contained in smoke, and an optical sensor may be used. For example, the smoke detection unit 140 may include a light-emitting unit 141 configured to emit light in a direction different from the movement direction of the smoke, and a light receiving unit 142 configured to receive the emitted light. For example, the light-emitting unit 141 may include a light-emitting element, and the light receiving unit 142 may include a photodiode.

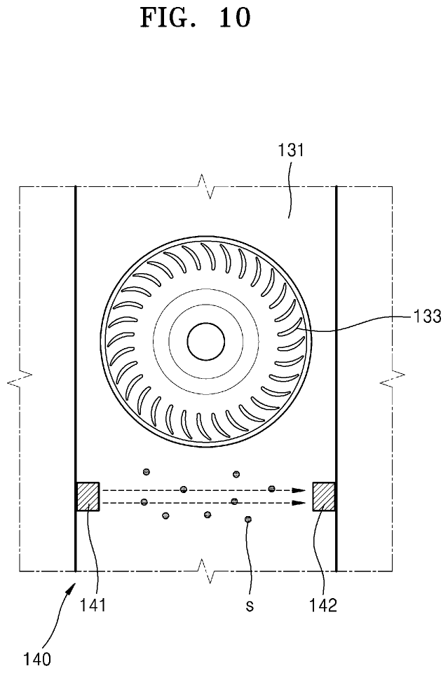

Referring to FIG. 10, the light-emitting unit 141 may emit light in a direction perpendicular to the movement direction of the smoke (or a direction in which the smoke passage 131 extends). When the smoke enters an optical path formed between the light-emitting unit 141 and the light receiving unit 142, absorption or scattering is caused by smoke particles s, and accordingly, the amount of light entering the light receiving unit 142 decreases. Through this, the smoke detection unit 140 may detect the generation and concentration of the smoke.

However, the configuration of the smoke detection unit 140 is not limited thereto, and may be variously modified into as long as it is configured to detect smoke. For example, the smoke detection unit 140 may include configurations based on other methods, such as light scattering or ionization, in addition to the photosensitive method.

The smoking module 100 according to an embodiment may further include a filter 150 to minimize discharge of smoke to the outside of the electronic cooking appliance 1. The filter 150 may be arranged in the smoke passage 131 and may be configured to remove smoke.

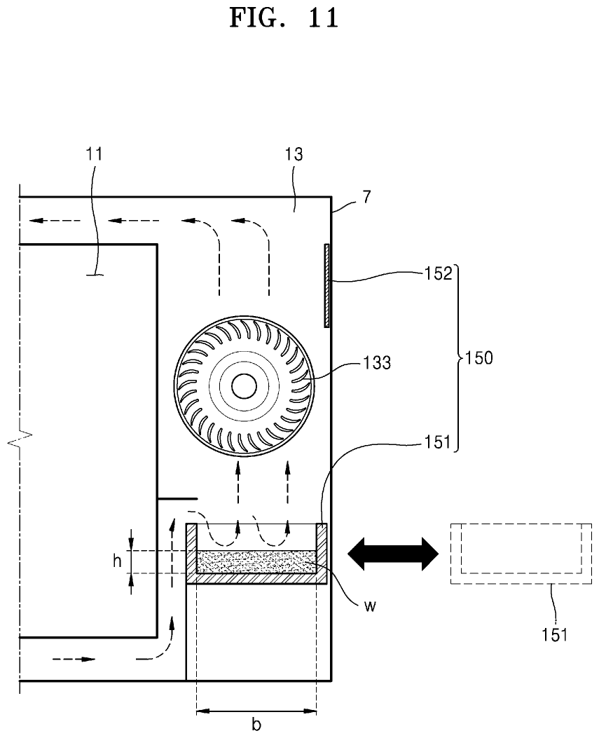

FIG. 11 is a diagram for describing the filter 150 according to an embodiment. Referring to FIGS. 9 and 11, the smoke passage 131 may have a structure through which smoke may circulate. For example, the smoke passage 131 may have a structure that allows smoke to move along the perimeter of the cooking chamber 11. Along the smoke passage 131, the smoke may sequentially move to the right, upper, left, and lower sides of the cooking chamber 11.

The filter 150 may be configured to remove smoke by using a liquid w. For example, the filter 150 may include a liquid cartridge 151 storing the liquid w. For example, water may be used as the liquid w. However, examples of the liquid w are not limited thereto and the liquid w may be variously modified as long as it is a liquid that absorbs smoke and is nonflammable.

The filter 150 is arranged in the smoke passage 131, and the smoke moving through the smoke passage 131 is exposed to the liquid w stored in the liquid cartridge 151. When the smoke passes over the liquid w, for example, water, the smoke comes into contact with the upper surface of the liquid w, and at this time, some of smoke particles contained in the smoke may be absorbed into the water. The smoke repeatedly comes into contact with the liquid w in the filter 150 while circulating through the smoke passage 131, and accordingly, the concentration of the smoke may be diluted.

The liquid w stored in the liquid cartridge 151 may be spread widely at a low height. For example, each of a horizontal width a (see FIG. 4) and a vertical width b of the liquid w may be greater than a height h. For example, each of the horizontal width a and the vertical width b of the liquid w may be greater than twice the height h. Accordingly, the contact area between the liquid w of the filter 150 and the smoke may increase.

The liquid cartridge 151 is detachable from a main body 7. Accordingly, the liquid w stored in the liquid cartridge 151 may be easily replaced or replenished. For example, the liquid cartridge 151 may be separated from the main body 7, then the liquid w stored in the liquid cartridge 151 may be discarded, and then the liquid cartridge 151 may be filled with a new liquid w and then mounted on the main body 7.

The filter 150 may further include a purification filter 152 to purify air. The purification filter 152 may be a high-efficiency particulate air (HEPA) filter. The purification filter 152 may purify the air containing the smoke once again, and thus prevent the smoke from being discharged to the outside of the electronic cooking appliance 1.

Hereinafter, a process of smoking an object to be cooked by using the electronic cooking appliance 1 according to the above-described embodiment will be described.

Before smoking the object to be cooked, the user removes the capsule lid 230 from the prepared capsule 200. The capsule lid 230 is removed to expose the smoke discharge unit 220 of the capsule 200 to the outside.

The user opens the capsule door 112 and inserts and places the capsule 200 with the smoke discharge unit 220 exposed, in the seating groove 111 of the capsule placement unit 110. At this time, in the seating groove 111, the combustion heater 121 is in the retraction position 121b.

Thereafter, the user closes the capsule door 112 to seal the capsule placement unit 110 to prevent smoke from leaking out. In conjunction with the operation of closing the capsule door 112, the combustion heater 121 moves from the retraction position 121b to the protrusion position 121a. When the combustion heater 121 moves to the protrusion position 121a, the combustion heater 121 is inserted into the capsule 200 and comes into contact with the smoking chips 201.

The control unit 2 heats the combustion heater 121 to generate smoke from the smoking chips 201. The generated smoke is discharged to the outside of the capsule 200 through the smoke discharge unit 220, and the discharged smoke moves to a movement passage connected to the capsule placement unit 110. The control unit 2 operates the blower 133 to move the smoke in the smoke passage 131 in a certain direction.

The smoke moving through the smoke passage 131 is supplied to the cooking chamber 11 through the smoke holes 1310. The smoke having moved into the cooking chamber 11 comes into contact with the object to be cooked. The smoke is repeatedly supplied through the smoke holes 1310 while circulating through the smoke passage 131, and accordingly, the object to be cooked may be smoked.

While smoking of the object to be cooked is in progress, or after the smoking is completed, the smoke is gradually removed while coming into contact with the liquid w of the filter 150. As the smoke moves to circulate and repeatedly comes into contact with the liquid w of the filter 150, the smoke is removed and the air is purified. The smoke is further removed by purification filter 152. Accordingly, only the purified air may be discharged to the outside of the electronic cooking appliance 1, and the smoke may be prevented from being discharged.

After finishing cooking, the user may complete a process subsequent to the smoking by simply opening the capsule door 112 and removing the capsule 200 containing the combusted smoking chips 201.

In the cooking appliance according to the above-described embodiments, smoking chips are encapsulated, and thus, smoking may be performed when cooking food by simply inserting and removing encapsulated smoking chips into and from the electronic cooking appliance, without the hassle of adjusting the amount of smoking chips or removing combusted smoking chips.

For the purposes of promoting understanding of the present disclosure, reference numerals are used in the preferred embodiments of the disclosure illustrated in the drawings, and particular terms are used to describe the embodiments, however, the present disclosure is not limited by the terms and should be construed to encompass all components that would normally occur to those skilled in the art.

Particular executions described herein are merely examples and do not limit the scope of the present disclosure in any way. For the sake of brevity, related-art electronics, control systems, software and other functional aspects of the systems may not be described in detail. Furthermore, line connections or connection members between elements depicted in the drawings represent functional connections and/or physical or circuit connections by way of example, and in actual applications, they may be replaced or embodied with various suitable additional functional connections, physical connections, or circuit connections. In addition, no item or component is essential to the practice of the present disclosure unless the item or component is specifically described as being “essential” or “critical”. As used herein, the term such as “comprising”, “including” and the like are used to be understood as being an open-ended term for description.

The use of the terms “the” and similar referents in the context of describing the present disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of the methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Furthermore, various changes and modifications will be readily apparent to one of ordinary skill in the art without departing from the spirit and scope of the present disclosure.

What is claimed is:

1. An electronic cooking appliance comprising:
a cooking chamber having a cooking space in which an object to be cooked is placeable;
a heating member configured to heat the object based on the object being placed in the cooking chamber; and
a smoking module configured to smoke the object placed in the cooking chamber,
wherein the smoking module comprises:
a capsule placement unit in which a capsule containing smoking chips is insertable and placeable therein;
a smoke generation unit configured to generate smoke by heating the smoking chips inside the capsule based on the capsule being placed in the capsule placement unit; and
a smoke transfer unit configured to transfer the smoke generated from the smoking chips to the cooking chamber.

2. The electronic cooking appliance of claim 1, wherein the capsule placement unit comprises a seating groove in which the capsule to be seated, the seating groove corresponding to an outer shape of the capsule, and
the smoking module further comprises a capsule door to open or close the capsule placement unit.

3. The electronic cooking appliance of claim 1, wherein the smoke generation unit comprises a combustion heater that is movable between a protrusion position in which the combustion heater penetrates an end of the capsule placed in the capsule placement unit, and a retraction position in which the combustion heater is retracted to enable a placement of the capsule in the capsule placement unit,
the smoking module further comprises a capsule door to open or close the capsule placement unit, and
based on the capsule door being closed, the combustion heater moves from the retraction position to the protrusion position.

4. The electronic cooking appliance of claim 3, wherein the combustion heater heats the smoking chips at a temperature of 480° C. or lower.

5. The electronic cooking appliance of claim 3, wherein an end of the combustion heater has a sharp shape to penetrate an end of the capsule based on the combustion heater being moved to the protrusion position.

6. The electronic cooking appliance of claim 1, wherein the smoke transfer unit comprises:
a smoke passage formed therein to connect the capsule placement unit with the cooking chamber so that the smoke moves therethrough; and
a blower arranged in the smoke passage to control a movement direction of the smoke.

7. The electronic cooking appliance of claim 6, further comprising a smoke detection unit configured to detect the smoke moving through the smoke passage.

8. The electronic cooking appliance of claim 7, wherein the smoke detection unit comprises a light-emitting unit configured to emit light, and a light receiving unit configured to receive the emitted light.

9. The electronic cooking appliance of claim 7, wherein the smoke detection unit is arranged upstream of the blower.

10. The electronic cooking appliance of claim 6, wherein the smoke passage is configured to allow the smoke to circulate therein, and
the smoking module further comprises a filter arranged in the smoke passage to remove the smoke by using a liquid.

11. The electronic cooking appliance of claim 10, wherein the filter comprises a detachable liquid cartridge storing the liquid, and a purification filter to purify air.

12. The electronic cooking appliance of claim 1, wherein the heating member is further configured to heat an inside of the cooking chamber or apply microwaves to the object to be cooked.

13. The electronic cooking appliance of claim 3, wherein the smoking module further comprises the capsule and the capsule comprises:
a basket accommodating the smoking chips;
a smoke discharge unit arranged at one end of the basket and configured to pass the smoke generated from the smoking chips; and
a capsule lid that blocks the smoke discharge unit and is removable from the basket, and
sizes of the smoking chips are 5 mm or less to enable combustion by the combustion heater.

14. The electronic cooking appliance of claim 13, wherein the smoke discharge unit formed as a mesh shape including mesh holes, and configured to block leakage of the smoking chips and pass the smoke generated from the smoking chips through the mesh holes, and
sizes of the mesh holes of the smoke discharge unit are less than the sizes of the smoking chips.

15. The electronic cooking appliance of claim 13, wherein the basket comprises:
a through hole formed at an other end of the basket, and into which the combustion heater is able to be inserted; and
a cover member provided at the other end of the basket, and covers the through hole.

16. The electronic cooking appliance of claim 3, wherein the combustion heater does not protrude toward the seating groove to enable insertion of the capsule into the seating groove.

17. The electronic cooking appliance of claim 3, wherein the capsule placement unit comprises a seating groove corresponding to an outer shape of the capsule.

18. The electronic cooking appliance of claim 5, wherein the smoke transfer unit comprises a smoke passage that is in communication with the capsule placement unit and the cooking chamber, and provides a passage through which the smoke moves, and a blower arranged in the smoke passage to control a movement direction of the smoke.
